(19) United States
(12) Patent Application Publication
(10) Pub. No.: US 2004/0076810 A1
(43) Pub. Date: Apr. 22, 2004

(54) Composite high temperature insulator

(75) Inventors: David P. Blain, Rocky River, OH (US); Robert E. Smith, Strongsville, OH (US)

Correspondence Address: UCAR Carbon Company Inc., Patent Law Department, 1521 Concord Pike, Suite 301, Brandywine West Building, Wilmington, DE, 19803, US

(73) Assignee: UCAR Carbon Company Inc.

(21) Appl. No.: 10/272,817

(22) Filed: Oct. 17, 2002

(51) Int. Cl. B32B 9/00; B32B 18/00; B32B 31/12; B32B 31/26; C04B 35/52; F16L 59/02; E04B 1/76

(52) U.S. Cl. 428/293.4; 428/408; 156/327; 156/332; 264/29.1; 264/29.5; 264/29.7; 156/89.25; 501/81; 501/99

(57) ABSTRACT

A composite high temperature insulator (A) includes a planar layer (10) having anisotropic thermal conductivity properties. A second planar layer (12) is formed from a rigid insulation material, such as a carbonized mixture of carbon fibers and a binder. The second layer is coextensive with the first layer and is preferably bonded thereto by a carbonaceous cement (44). When used to insulate a heat source, such as a furnace (50), convective heat is directed back to the source by the reflective surface (16) of the inner, anisotropic layer (10). Heat which enters the anisotropic layer is dissipated evenly through the plane of the layer along a plurality of heat paths defined by a plurality of layers (14) of flexible graphite. Accordingly, heat which reaches the outer, second layer (12) results in fewer hot spots than occur with a conventional rigid insulation material, thereby reducing the total amount of insulation material required to achieve a desired level of thermal insulation.

### BACKGROUND OF THE INVENTION

1. Field of the Invention

The present invention relates to a thermal insulation material suited to high temperature applications. In particular, it relates to a composite material comprising one or more layers of flexible graphite and one or more layers of an isotropic carbon insulator, and will be described with particular reference thereto.

2. Discussion of the Art

Thermal insulation materials formed from carbon fibers exhibit excellent resistance to heat flow, even at high temperatures. Traditionally, a mixture of carbonized cotton or rayon fibers and a binder, such as a phenolic resin, furfuryl alcohol, or starch, is poured into a form or mold fitted with a filter, known as a bleeder cloth. A vacuum is pulled on the bleeder cloth to remove the excess binder. The fibers build up on the bleeder cloth and when the desired thickness is achieved, the fibers are removed as a mat. The mat is dried and carbonized, for example, by induction heating to a temperature of about 1000-1800° C., or higher. The rigid mat thus formed is then machined into desired shapes and sealed or coated, for example with a phenolic resin.

Such materials have good thermal insulating properties in a direction which is perpendicular to the plane of the sheet. However, hot spots can occur since dissipation of conductive heat in the plane of the sheet is relatively slow.

U.S. Pat. No. 4,279,952 to Kodama, et al. discloses an insulation material formed by bonding a graphite sheet to each of the two opposite surfaces of a carbon fiber felt sheet by means of a carbonaceous binding agent. Such materials tend to be low in strength and thus difficult to handle.

U.S. Pat. No. 6,387,462 to Blain, et al. discloses a thermal insulating shell for a high temperature reactor. The shell is in the form of a spiral wound sheet of anisotropic flexible graphite, which has been bonded to a sheet of heat decomposable carbon based material with an in-situ cured phenolic resin. The flexible graphite sheet is produced by treating graphite, for example, with an acid intercalant solution, so that the spacing between the carbon layers or laminae which make up the graphite is appreciably opened up so as to provide a marked expansion in the direction perpendicular to the layers, that is, in the “c” direction and thus form an expanded or intumesced graphite structure in which the laminar character is substantially retained. Graphite flake which has been greatly expanded in this way can be formed into cohesive or integrated sheets by compressing or compacting the expanded flake material, without the use of a binder. Because the shell is an integral structure, it cannot be readily removed in sections.

The present invention provides a new and improved insulation product and method of formation, which overcome the above-referenced problems and others.

### SUMMARY OF THE INVENTION

In accordance with one aspect of the present invention, a method of forming a composite insulation material is provided. The method includes securing a flexible graphite material or a laminate material comprising a plurality of overlapping layers of a flexible graphite material to a layer of a carbonaceous insulation material.

In accordance with another aspect of the present invention, a composite article for thermal insulation is provided. The article includes a first layer comprising a carbonaceous insulation material derived from carbon fibers and a carbonizable binder and a plurality of layers of a flexible graphite material, the layers of flexible graphite material and layer of carbonaceous material being bonded together to form the composite article.

In accordance with another aspect of the present invention, a method of providing thermal insulation for a high temperature radiant heat source is provided. The method includes positioning a self supporting insulation member adjacent the high temperature radiant heat source to insulate the heat source. The member includes a first anisotropic layer having a laminated structure in which thermal conductivity in a plane parallel to a surface of the layer is at least ten times the thermal conductivity in a direction perpendicular to the surface. The member also includes a second layer of a carbonaceous insulation material derived from a mixture of carbon fibers and a carbonizable binder. The first layer dissipates the heat through the plane parallel to the surface, inhibiting formation of hot spots in the second layer.

An advantage of at least one embodiment of the present invention is that it enables a system to be isolated from radiant, conductive, and convective heat transfer mechanisms.

Another advantage of at least one embodiment of the present invention is that hot spots in a thermal insulation material are distributed and reduced.

Another advantage of at least one embodiment of the present invention is that it enables effective insulation of a body using a lower thickness of insulation materials.

Still further advantages of the present invention will be readily apparent to those skilled in the art, upon a reading of the following disclosure and a review of the accompanying drawings.

### BRIEF DESCRIPTION OF THE DRAWINGS

FIG. 1 is a partial perspective view of a composite sheet material, according to the present invention;

FIG. 2 is an enlarged side view of the composite sheet material of FIG. 1, showing heat flow from an exemplary heat source;

FIG. 3 is a flow chart showing an exemplary process for forming the sheet material of FIG. 1;

FIG. 4 is a side sectional view of a multi-layer arrangement of graphite sheet and resin-coated heat-decomposable material prior to curing, according to the present invention;

FIG. 5 is a side sectional view of a second embodiment of a composite sheet material, according to the present invention;

FIG. 6 is a perspective view of a third embodiment of a composite material, according to the present invention; and

FIG. 7 is a perspective view of a furnace insulated with the composite material of FIG. 1.

### DETAILED DESCRIPTION OF THE PREFERRED EMBODIMENT

A lightweight, self-supporting composite insulation material A suited to applications above about 1000° C., such as non-oxidizing atmospheres and/or vacuum environments, is formed from one or more layers of an anisotropic foil, preferably in the form of a multi-layer laminate, and a carbonaceous insulation material, such as a graphite rigid insulation material. The composite material is effective for both reflecting radiant heat and minimizing loss of thermal energy by conduction.

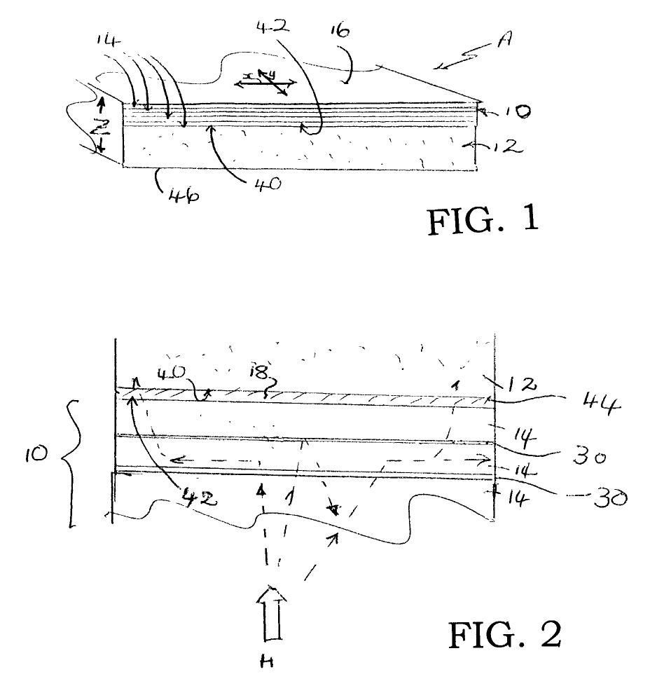

With reference to FIG. 1, one embodiment of the composite insulation material A is shown. The material A includes first and second layers 10, 12. The first layer 10 is in the form of a laminate comprising several layers 14 of an anisotropic insulating material, such as a flexible graphite sheet. The layers 14 of graphite sheet are joined together by carbonaceous layers. The layer 10 is preferably from about 0.1 cm to 10 cm in thickness. More preferably, the layer 10 is less than about 2 cm in thickness, most preferably, layer 10 is about 0.2-1.0 cm in thickness.

The second layer 12 is coextensive with the first layer 10 and is formed from the carbonaceous insulation material. The layer 12 may be from about 0.5 cm to about 20 cm in thickness, more preferably, about 1-10 cm in thickness, depending on the application for which the insulation material is intended. For example, for insulation of furnaces which operate at temperatures of around 1000-1500° C., a thickness of about 1-3 cm is preferred (i.e., as measured perpendicular to the plane of the layer, in the “z” axis direction). For higher temperature operations, or operations where a greater level of insulation is desired, the thickness of the layer 12 may be increased. Where a thickness of greater than about 12 cm for insulation layer 12 is desired, a support sheet or frame may be provided for the material A. Layer 12 preferably has a density of less than about 1 g/cm³, more preferably, about 0.1-0.5 g/cm³. Density, as used herein, is determined by weighing a sample of the layer and dividing the weight by the sample volume, as determined by multiplying the length, width, and height of the layer.

It has been found that the heat spreading benefits of the layer 10 are optimized at a thickness of about 0.4 to 0.6 cm, which is generally independent of the temperature of the heat source. Where devices operating at high temperatures are to be insulated, it is preferable to increase the thickness of layer 12 rather than layer 10.

The composite insulation material A preferably has an overall thickness of about 1-30 cm, more preferably, about 1-10 cm, and most preferably, 1.5-4 cm, allowing it to be self-supporting and resistant to breakage, yet lightweight and easy to handle, when formed into sheets or boards of about 0.5-2 meters, or more, in the x and/or y directions. For convenience, a thickness of about 2.5-2.6 cm allows the board to be interchanged with many conventional insulation boards formed solely of a rigid insulation material. As illustrated in FIG. 2, the composite insulation material A is preferably oriented such that layer 10 is closest to a source H of radiant heat which is to be insulated.

The composite insulation material A is particularly effective at providing thermal insulation. First, the layer 10 has a reflective outer surface 16 on the outermost graphite layer 14 (i.e., the layer facing heat source H), which tends to reflect heat back to the source H. GRAFOIL® flexible graphite material has a reflectivity of about 0.4-0.6, for example, as determined by subtracting the optical emissivity from 1, and thus is a suitable material for use as graphite layer 14. Second, the presence of first layer 10 tends to reduce the occurrence of hot spots in layer 12. Third, layer 12, provides a thermal barrier to conduction of heat due to its low thermal conductivity.

It is suggested that the anisotropic graphite foil sheets 14, due to their higher conductivity in the plane of the layer 10 (i.e., in the “x” and “y” axes), as compared to the conductivity in a direction perpendicular thereto (the “z” axis), tend to dissipate the heat. For example, a layer 10 of about 0.63 cm in thickness (“z” direction) may have a thermal conductivity of about 3 W/m·K in the z direction and about 140 W/m·K in the x and y directions. (Unless otherwise specified, thermal conductivity measurements were made at a temperature of 800° C. in an argon atmosphere). In contrast, a layer 12 of carbonaceous material about 1.9 cm thick may have a thermal conductivity of about 0.2-0.3 W/m·K in the z direction and about 0.4 in the x and y directions, using the same measurement procedures. Thus, the carbonaceous material is more isotropic in character than the graphite foil sheets.

Preferably, the thermal conductivity of layer 10 in the x and y directions is at least 10 times, more preferably, at least 20 times the thermal conductivity in the z direction. Preferably, the thermal conductivity of layer 10 in the z direction is less than about 5 W/m·K and the conductivity in the x and y directions is at least 50 W/m·K. While the exact mode of heat transfer is not fully understood, it is proposed that each interface 18 between layers 14 dissipates radiant heat through its intrinsic emissivity. Due, in part, to the anisotropic properties of the graphite sheets 14, the heat is spread over a wide area, in the x and y directions (see dashed lines in FIG. 2 indicating exemplary directions of heat flow). The surface of each layer 14 and the multiple reflections possible also assist in heat spreading. This allows more effective use of the specific heat isolation properties of the generally isotropic, insulator layer 12. The overall thickness of insulation can be reduced, as compared with a conventional insulation formed solely from the carbonaceous insulator, due to the more uniform distribution of heat which is achieved.

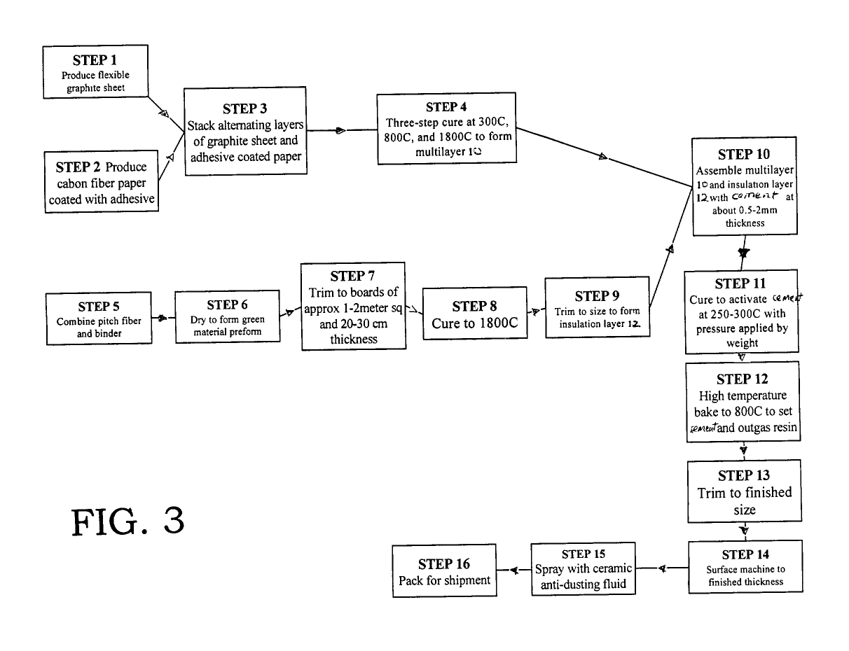

FIG. 3 shows the steps of an exemplary process for forming the composite board material A. Steps 1-4 illustrate the preparation of the layer 10, while steps 5-9 illustrate the preparation of layer 12. Steps 10-16 illustrate the assembly and optional finishing steps in forming the two-layer composite A.

It will be appreciated that the process may include additional or fewer steps, or that additional layers intermediate or adjacent to the first and second layers 10, 12 may be provided.

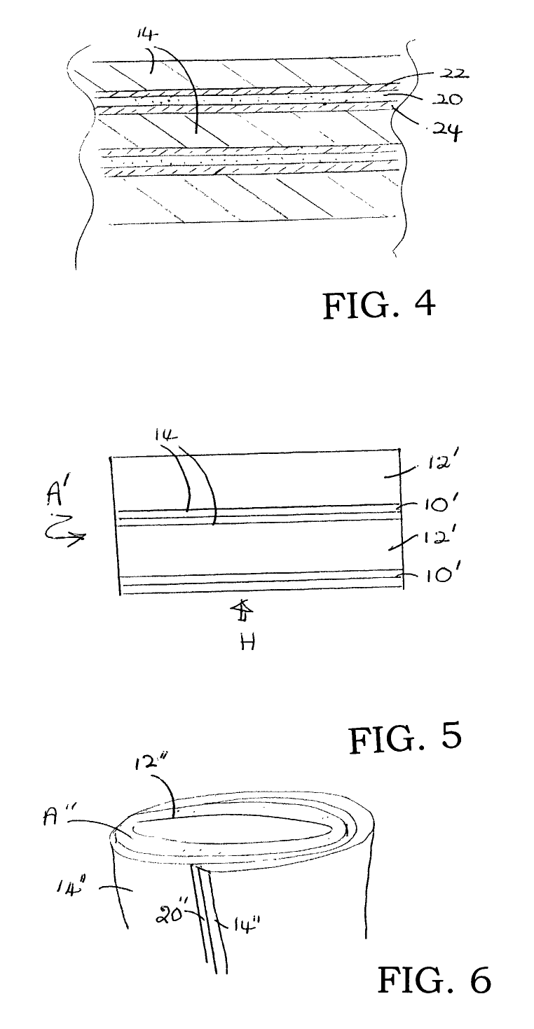

As illustrated in FIG. 4, layers 14 of the graphite sheet are bonded together to form layer 10. FIG. 1 shows five (5) layers of graphite sheet, although it is contemplated to form layer 10 from two (2) to about twenty (20) layers. More preferably, four to eight layers 14 are employed. Suitable graphite sheet for use as layers 14 is sold, for example, under the tradename GRAFOIL® by Graftech Inc., Lakewood, Ohio. To bond the layers 14 of graphite sheet together, the layers 14 are interlayered with a thin sheet 20 of heat decomposable carbon-based material, which is coated or impregnated with an adhesive, such as a phenolic resin (Step 3). As shown in FIG. 4, the layers 20 are co-extensive with the adjacent sheets 14 of flexible graphite. Each thin sheet 20 of heat decomposable carbon-based material provides a path for the escape of gases which develop in the course of in situ curing of the phenolic resin 22, 24 (Step 4). Contact thus occurs between resin layers 22, 24 applied on both, i.e., the opposite, sides of the sheet 20 of heat decomposable carbon-based material during curing of the phenolic resin. This results in a strong continuous bonding layer of phenolic resin between, and co-extensive with, the adjacent sheets 14 of flexible graphite. The resulting layer 10 preferably has a density of less than 2 g/cm³, more preferably, about 1-1.2 g/cm³.

A suitable adhesive for use as layers 22, 24 is a phenolic resin, such as PLYOPHEN 43703 Phenolic Resin available from Occidental Chemical Corporation, North Tonawanda, N.Y. The resin may be mixed with a solvent, such as methanol, to make spreading easier. The resin is heated at an appropriate temperature and for sufficient time to effect cure, the time and temperature being dependent on the type of resin or other adhesive used. (Step 4) Preferably, Step 4 further includes heating the layer 12 in a non-oxidizing atmosphere to a final temperature of about 1700° C., or higher, depending on the expected use temperature (optionally, with an intermediate curing step at 800° C.) to convert the resin to a layer 30 of carbon (FIG. 2) and to prevent outgassing during use. Other carbonizable adhesives are also suitable for bonding the sheets 14 together.

Kraft paper can be used as the heat decomposable, carbon based sheet 20. Alternatively, a polyacrylonitrile (PAN) carbon fiber tissue or pitch fiber tissue available from Technical Fibre Products Limited, Cumbria, England, is used as the sheet 20.

In the course of curing, the carbon based heat decomposable sheet 20 is gradually reduced to particles of carbon char (30 in FIG. 2) while the gases which evolve from the curing of the resin 22,24 and the charring of carbon-based sheet 20, escape through a temporary channel created by the decomposing of sheet 20 and thus do not cause any delamination of the flexible graphite sheets 14 in the layer 10. Also, the decomposition of the heat decomposable sheet 20 into small, isolated particles of carbon enables the substantially complete, co-extensive resin bonding of the flexible graphite sheets 14, as shown in FIG. 2. It should be noted that under microscopic examination, pores are typically visible through the cured adhesive of about 0.1 mm, or less in diameter, but these do not impair the bonding significantly.

For example, a layer 10 of about 0.5 cm in final thickness is created by alternating about six layers 14 of GRAFOIL® sheet of about 0.75-0.9 mm in thickness with about five layers 20 of resin-coated paper, each about 0.3 mm thick.

The layer 10 is preferably bonded to the layer 12 with a curable, high temperature, carbonaceous cement paste (Step 10). One suitable cement paste is described in U.S. Pat. No. 6,214,158 to Chiu, et al. The specification of U.S. Pat. No. 6,214,158 is incorporated herein by reference. Preferably, the cement paste composition comprises a carbon filler present in an amount of about 20 to about 60 wt. %, a polymerizable monomeric binder system present in an amount of about 7 to about 30 wt. %, and solvent, such as a furan derivative solvent present in an amount of about 15 to about 60 wt. %, although other carbonizable adhesives are also suitable. The composition optionally contains a catalyst, such as ZnCl₂, although the catalyst may be eliminated by selection of a suitable curing temperature.

The carbon filler in the cement paste preferably includes carbonaceous particles wherein at least about 90% of the particles have a particle size less than about 20 micrometers. Suitable carbon fillers are carbon black, pitch, coke flour, petroleum coke flour, and mixtures thereof.

The polymerizable monomeric binder system preferably includes one or more esters and an aromatic diamine. A preferred polymerizable monomeric binder system includes a dialkyl ester of an aromatic tetracarboxylic acid, an aromatic diamine, and a monoalkyl ester of an acid selected from the group consisting of 5-norbornene-2,3-dicarboxylic acid and phthalic acid.

A preferred cement paste includes a dimethyl ester of 3,3′,4,4′-benzophenonetetracarboxylic acid, 2,2′-bis(4-[4-aminophenoxyl]phenyl)propane and a monomethyl ester of 5-norbornene-2,3-dicarboxylic acid with furfuryl alcohol. This composition has a glass transition temperature of about 280° C. after curing by heating to about 240°-300° C. and holding for about 2 hours (Step 11). Pressure is preferably applied during the curing step to ensure intimate contact between the layers. For example, pressure is applied by a weight or weights loaded onto the material.

Upon curing, the cement paste composition maintains a strength of at least about 140 kg/cm² at room temperature after heat treatment at about 3000° C., even when cured at a substantially lower temperature of at least about 200° C. Subsequent heating of the monomeric binder system (e.g., to about 800° C.) causes further cross-linking, producing a stronger and more stable cement for use at service temperatures greater than the initial glass transition temperature of the cured cement and also reduces any tendency for outgassing during use (Step 12).

The curable cement composition is optionally used along with a pre-coat in an adhesive system for attaching together the layers 10, 12. For example, the pre-coat comprises about 27 wt. %, of a monomeric system comprising a dimethyl ester of 3,3′,4,4′-benzophenonetetracarboxylic acid, 2,2′-bis(4-[4-aminophenoxyl]phenyl)propane and a monomethyl ester of 5-norbornene-2,3-dicarboxylic acid dissolved in about 65 to about 85 wt. % furan solvent, such as furfuryl alcohol. The pre-coat and cement are preferably stored separately at about 5° C.

The pre-coat, if used, is applied to the surfaces 40, 42 with any conventional method, such as a brush or roller, until a puddle remains and the surfaces are substantially saturated with the pre-coat.

With particular reference to FIG. 2, the carbonaceous cement is then typically applied with a trowel to one or both of the surfaces 40, 42. After the surfaces are coated with the cement, the surfaces are aligned and joined together. After joining, it is preferable to slide, back and forth, one or both of the surfaces along the plane of the joint to reduce the thickness of the cement layer between the joined surfaces. Preferably, the thickness of the applied cement is less than about 0.3 cm, and most preferably, about 0.1-0.2 cm, or less. The fineness of the coke flour and carbon black effectively allows for such a thin joint.

The joined layers 10, 12 are clamped together using any conventional method such as weights, clamps, hydraulic presses and the like, preferably, at a pressure of about 0.14 to about 3.5 kg/cm², depending on the size of the layers to be cemented (Step 11). The joined layers 10, 12 are preferably cured by heating the joined bodies at an elevated temperature of at least about 200° C., more preferably, about 250° C.-300° C. Alternatively, the joined layers are rapidly heated to 60-100° C. and held for about 4 to about 6 hours followed by heating to about 240 to about 275° C. at a rate of about 10 to about 15° C./hour. The joined carbon layers are held for about 2 to about 6 hours at this elevated temperature. A final high temperature bake (Step 12) sets the cement and allows volatile components to outgas.

The cured cement and precoat are converted to a layer 44 of generally carbonaceous material during Step 12. The carbonized joint 44 provides a further barrier to heat transfer. Once cured, the external surfaces 16, 46 of the joined carbon layers 10, 12 are machined to provide a smooth overall finish.

Further processing steps may include trimming of the board A to appropriate size and/or machining to an appropriate thickness and spraying the board with an anti-dusting compound, such as a ceramic anti-dusting fluid.

In FIG. 3, steps 1-4 are shown as being carried out contemporaneously with steps 5-9, although in separate processes. It is also contemplated that the layers 14 of graphite foil may be assembled on the green insulation material prior to final curing, such as after an initial drying of the insulation material to 300° C. or 800° C., and that the curing of insulation material 12 and layer 10 may be carried out in a single step by heating the two layers together to a final temperature of about 1800° C.

The flexible graphite sheet material used for layers 14 is preferably formed by roll-pressing and compressing expanded particles of graphite. Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10-decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will generally be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend can be exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1200° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e., exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet thus formed is coherent, with good handling strength, and is suitably compressed, e.g., by roll-pressing, to a thickness of about 0.075 mm to 3.75 mm and a typical density of about 0.1 to 1.4 grams per cubic centimeter (g/cc).

Roll pressed flexible graphite sheet is known to be a relatively good thermal barrier in the direction (“z” axis) perpendicular to the parallel planar surfaces of the sheet. The thermal conductivity along and parallel to the sheet surfaces (“x” and “y” axes) is approximately twenty (20) or more times greater than through its thickness (“z” axis).

The carbonaceous thermal insulation material in the layer 12 is preferably formed from a reinforcement material, such as carbon fibers, held together by a carbon matrix derived from a carbonizable liquid binder. Commercially available carbonaceous insulation materials are generally produced from a carbon fiber filler, derived from a cotton, rayon, polyacrylonitrile (PAN), polyacetylene, cellulose, pitch precursor, or other carbonizable material, and a binder comprising a phenolic resin, furan derivative, such as furfuryl alcohol, insoluble starch, or soluble sugar. The binder may also include a solvent for forming a solution of the binder.

For example, the thermal insulation material may be prepared by combining about 0.2-80% of carbonized fibers, and the balance binder. In one method, 0.2-80 wt. % of pitch-based fibers are combined with 99.8-20 wt. % of a phenolic binder (or an insoluble starch mixed with water). In another method, 20-80% fibers are mixed with 20-80% of a 10-60% aqueous sugar solution. In either case, the method continues with molding under vacuum (Step 5), drying the woven material mixture to form a solid “green” preform (Step 6), and carbonizing at about 1000° C., or higher, preferably, at around 1800° C. (Step 8).

The fibers can be in the form of individual fibers, bundles of fibers, yarns, mats, felts, woven fabrics, or chopped, milled or other finely comminuted fibers, or combinations thereof. Preferably, the cotton or other fibers are carbonized in a furnace at about 800° C. to form carbonized fibers, which are then bundled and milled or chopped to appropriate size. A particularly preferred carbonized fiber is an isotropic pitch fiber obtained, for example, from Ashland Fibers under the tradename Carboflex™, or from AnShan Chemical Co., China. These fibers are particularly uniform and maintain product properties. They have a density of about 1.6 g/cm³, a diameter of about 12 microns, and are primarily carbon (i.e., greater than 99% carbon). The fibers are preferably milled to an average length of about 100 to 1600 microns. Optionally, coking additives or other additives may be included in the binder, such as aluminum phosphate or zinc chloride.

The carbonized insulation material may then be trimmed to a desired size and thickness for forming insulation layer 12 (Step 9). It comprises primarily graphite (i.e., at least 95% carbon, more preferably, at least 98% carbon, most preferably, greater than 99.5% carbon).

The density of the carbonized insulation material preferably ranges from about 0.1 to about 1.0 g/cm³, more preferably, about 0.1 to about 0.5 g/cm³, most preferably, about 0.15-0.25 g/cm³, and has a compressive strength which ranges from about 1 to about 20 kg/cm², and a thermal conductivity from about 0.05 to about 0.5 W/ m·K at 800° C., measured in an argon atmosphere.

In another method, hot pressing is used to form the “green” insulation material, followed by carbonization. Thermal insulation materials formed by hot pressing tend to have a higher density than vacuum molded materials, and thus thermal conductivities tend to be higher.

While the board A is described with reference to a rigid, self supporting layer 12, such as the pitch fiber based insulation material described above, it is also contemplated that layer 12 may comprise a less rigid or flexible material, such as a felt. The felt can be formed from carbon or graphite, optionally impregnated with a phenolic resin or other carbonizable resin.

FIG. 5 shows an alternative embodiment of the material A′, where similar elements are indicated by a prime (′). Insulation material A′ includes two or more layers 12′ (two are shown) of carbonaceous insulation, which are interleaved with a layer or layers 10′ (two are shown) of flexible graphite laminate. In this embodiment, it is contemplated that the layer 10′ may comprise only one or a plurality of graphite layers 14′ (two are shown in FIG. 5, although it is contemplated that many such layers 14′ may be employed.

It is also contemplated that the insulation material may take the form of a cylindrical member A″, as shown in FIG. 6, where similar elements are identified with a double prime (″). To form the cylindrical member A″, a cylindrical insulation tube 12″ is formed, for example by coring a block of insulation material. Alternatively, the tube 12″ is formed by a centrifugal casting method in which a slurry of carbon fibers in a binder (preferably an aqueous sugar solution) is fed into a rotating foraminous drum. The excess binder passes through apertures in the drum and a cylindrical mat of fibers builds up within the drum. The mat is dried to form a solid “green” preform (Step 6), and carbonized at about 1000° C., or higher, preferably, at around 1800° C. (Step 8). For additional background regarding centrifugal casting, the specification of granted U.S. patent application Ser. No. 10/185032 filed on or about Jun. 28, 2002, is incorporated herein by reference in its entirety. The layer 10″ is formed by spirally winding a GRAFOIL® sheet 14″, or similar graphite sheet around or within the tube 12″. A sheet of resin coated or impregnated paper 20″ is coextensive with the graphite sheet and interposed between the sheet 14″ and the tube 10″ or, for outer layers, a more interior winding of the sheet. The spiral wound layer 10″, thus formed, is cured in situ on the tube 12″. In this embodiment, therefore, there is no need to position an additional layer of cement between the layer 10″ and the layer 12″.

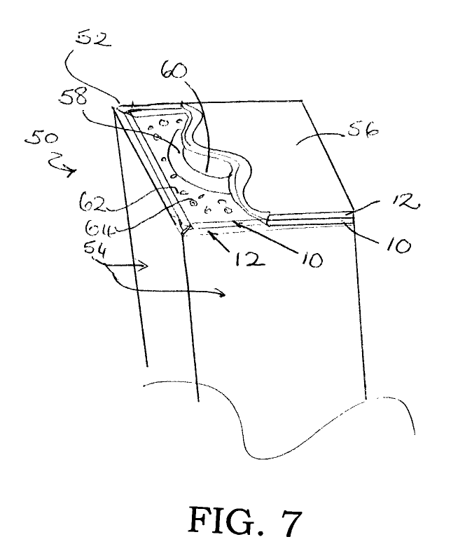

With reference now to FIG. 7, in a preferred embodiment, a high temperature reactor is indicated schematically at 50, representing, for example, a reactor employing a substantially non-oxidizing atmosphere and which operates at temperatures of about 1000° C. and higher. A heat shielding self-supporting shell is shown at 52 assembled from an insulation board, formed according to the present invention. Specifically, the shell 52 is formed from self-supporting panels 54 of the insulation material A. Top panels 56 and bottom panels (not shown) are also formed from the material A. The panels surround a furnace housing 58, such as an inductively heated graphite susceptor, which defines an interior chamber 60 for receiving items to be treated. A space 62 between the panels 54 and the housing 58 is preferably filled with a particulate or flexible insulation material, such as uncompressed particles 64 of expanded graphite. More than one shell 52 may be provided. For example, a second shell (not shown) may surround and be spaced from the shell 52, the space being also packed with insulation material similar to material 64. The panels are readily removed and/or replaced, due to their structural integrity, for example, when components of the furnace need to be repaired or replaced. The panels 54 are removed and replaced singly or as a preassembled shell 52.

A portion of the heat energy radiated from the high temperature housing 58 is reflected by the surface 16 of layer 10 back toward the housing. A portion of the heat energy passes partway through layer 10 and reaches one or other of the layers 14, which are formed of the anisotropic flexible graphite sheet, and is reflected back to the housing 58 from the surface of the layer 14 (FIG. 2). Some of the radiant heat energy from housing 58 is not reflected back and causes the temperature at locations in the layer 10 to rise. Heat at these locations is rapidly transferred and spread by conduction throughout the anisotropic flexible graphite sheet 14 in all directions in the plane of flexible graphite sheet 14. Thus, the temperature throughout each sheet 14 is essentially uniform and the presence of persistent hot spots is avoided. The heat entering layer 12 is thus more evenly distributed than is the case where the layer 10 is absent.

Without intending to limit the scope of the present invention, the following example indicates the thermal insulation advantages of the insulation material A.

### EXAMPLE

A layer 10 about 0.535 cm thick was formed from about 6 layers 14 of GRAFOIL® sheets sandwiched together with alternating layers of kraft paper 20 coated on both sides with a phenolic resin 22, 24. The layered assembly was subjected to a three step cure at 300° C., 800° C., and 1800° C. to form layer 10. The thermal conductivity of layer 10 was 3W/m·K in the z direction and 140 W/m·K in the plane of the layer (x and y directions).

Rigid insulation material for layer 12 was formed from pitch fibers and a binder, which was cured to a final temperature of 1800° C. in a non-oxidizing atmosphere. The rigid insulation material had a thickness of 1.605 cm and a thermal conductivity of 0.2 W/m·K in the z direction and 0.2 W/m·K in the plane of the layer (x and y directions).

Layer 12 was attached to layer 10 with a cement paste composition comprising 20 to about 60 wt. % of a carbon filler, 7 to about 30 wt. % of a polymerizable monomeric binder and about 20 to about 60 wt. % furfuryl alcohol. The binder included a dimethyl ester of 3,3′,4,4′-benzophenonetetracarboxylic acid, 2,2′-bis(4-[4-aminophenoxyl]phenyl)propane, and a monomethyl ester of 5-norbornene-2,3-dicarboxylic acid, without a precoat, at about 0.25 cm thickness and cured under pressure at 250° C. to 300° C. to activate the resin. A high temperature bake at 800° C. was used for setting the resin and outgassing of volatile components. Surface machining was used to trim the board to a thickness of 2.54 cm and the boards were trimmed to size. Exterior surfaces were sprayed with a ceramic antidusting fluid. The resulting board A had a thermal conductivity of 0.33 W/ m·K.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

1. A method of forming a composite insulation material comprising:
securing a laminate material comprising a plurality of overlapping layers of a flexible graphite material to a layer of a carbonaceous insulation material.

2. The method of claim 1, wherein the step of securing comprises:
securing the layer of carbonaceous insulation material to the laminate material with an effective amount of carbonaceous cement; and
heating the secured insulation and laminate material.

3. The method of claim 2, wherein the carbonaceous cement comprises:
a carbon filler present in an amount of about 20 to about 60 wt. %;
a polymerizable monomeric system present in an amount of about 7 to about 30 wt. % comprising at least one ester and an aromatic diamine;
a solvent present in an amount of about 15 to about 60 wt. %.

4. The method of claim 3, wherein the polymerizable monomeric system comprises a dialkyl ester of an aromatic tetracarboxylic acid, an aromatic diamine, and a monoalkyl ester of an acid selected from the group consisting of 5-norbornene-2,3-dicarboxylic acid and phthalic acid; and
the solvent includes a furan derivative solvent.

5. The method of claim 3, wherein the step of heating comprises:
heating the secured insulation and laminate material to a temperature of at least about 250° C.

6. The method of claim 1, further comprising:
adhering adjacent layers of the flexible graphite material with a carbonaceous adhesive, thereby forming the laminate material.

7. The method of claim 6, wherein the step of adhering comprises:
interposing sheets of a carbonizable material which supports the carbonaceous adhesive thereon between the adjacent layers of flexible graphite; and
heating the interposed sheets and layers of flexible graphite to form the laminate material.

8. The method of claim 1, further comprising:
heating a mixture of a carbon reinforcement and a carbonizable binder to a temperature of at least about 1000° C., thereby forming the carbonaceous insulation material.

9. The method of claim 8, wherein the carbon reinforcement comprises carbonized fibers derived from cotton, rayon, cellulose, pitch, polyacrylonitrile, or a combination thereof.

10. The method of claim 8, wherein the carbonizable binder is selected from the group consisting of phenolic resins, furan derivatives, pitch, insoluble starches, soluble sugars, solutions thereof, and combinations thereof.

11. The method of claim 8, wherein the carbon reinforcement comprises pitch fibers and the binder comprises a phenolic resin.

12. A composite article for thermal insulation comprising:
a first layer comprising a carbonaceous insulation material derived from carbon fibers and a carbonizable binder; and
a plurality of layers of a flexible graphite material, the layers of flexible graphite material and the layer of carbonaceous material bonded together to form the composite article.

13. The composite article of claim 12, wherein a portion of the plurality of the layers of the flexible graphite material are bonded together with a carbonaceous insulation material to form a laminate.

14. The composite article of claim 13, wherein the laminate has a thickness of less than about 10 cm.

15. The composite article of claim 14, wherein the laminate has a reflective surface for reflecting heat.

16. The composite article of claim 12, further including:
a second layer of a carbonaceous insulation material, the first and second layers of carbonaceous insulation material spaced by at least one of the layers of flexible graphite material.

17. The composite article of claim 12, wherein the carbonaceous material has a density of less than about 1 g/cm³.

18. The composite material of claim 12, wherein the carbonaceous material has a thermal conductivity of less than about 0.5 W/m·K measured at a temperature of 800° C.

19. The composite material of claim 12, wherein the carbonaceous material has a thickness of from about 0.5-10 cm.

20. A method of providing thermal insulation for a radiant heat source comprising:
positioning a self-supporting insulation member adjacent the radiant heat source to insulate the heat source, the insulation member including:
a first anisotropic layer comprising a laminate in which thermal conductivity in a plane parallel to a surface of the layer is at least ten times the thermal conductivity in a direction perpendicular to the surface, and
a second layer of a carbonaceous insulation material derived from a mixture of carbon fibers and a carbonizable binder;
the first layer dissipating the heat through the plane parallel to the surface, inhibiting formation of hot spots in the second layer.

21. The method of claim 20, wherein the first layer comprises a plurality of overlapping layers of flexible graphite.
